(19) United States
(12) Patent Application Publication
(10) Pub. No.: US 2013/0334236 A1
(43) Pub. Date: Dec. 19, 2013

(54) Security Device for Gas Cylinders

(71) Applicant: Joachim Gerstel, Mulheim a.d. Ruhr (DE)

(72) Inventor: Joachim Gerstel, Mulheim a.d. Ruhr (DE)

(21) Appl. No.: 14/002,706

(22) PCT Filed: Mar. 1, 2011
(86) PCT No.: PCT/EP2011/053034

§ 371 Date: Aug. 31, 2013

(51) Int. Cl. F17C 13/00

(52) U.S. Cl. CPC F17C 13/00
USPC 220/724

(57) ABSTRACT

A security device for gas cylinders or crates of gas cylinders, comprises a carrier adapted to be fixed to the gas cylinder or crate; a REID-tag provided on said carrier having a storage for storing an expiry date or any other data regarding the durability of the gas contained in said gas cylinder; a processor for checking the durability; and a display indicating the durability and/or passing of the expiry date. The security device may have a closed electric circuit with a current- or voltage supply adapted to be switched off; and means for generating an optic-, acoustic- and/or wireless transmittable alarm signal upon disruption of the electric circuit.

### SUMMARY

1. Technical Field

The invention relates to a security device for gas cylinders. Gas cylinders are, in particular, metal containers containing, for example, pressurized technical gases or gas mixtures, such as noble gases, oxygen or hydrogen. The gases may serve as gas for calibration purposes. With such applications it is important to have a known consistency and purity. The consistency and the purity of the gases may change with time. Therefore, tha gases contained in such gas cylinders have a limited durability, which may be expressed as a expiry date. Especially with expensive gases and gas mixtures there is a risk, that the gas cylinders are stolen.

2. Prior Art

It is known to fix an expiry date to gas cylinders in printed form. It is, however, disadvantageous that such an expiry date may easily manipulated or removed.

3. Disclosure of the invention

It is an object of the invention to improve the security of gas cylinders. It is also an object of the invention to provide a security device for gas cylinders which shows the expiry date with higher security regarding manipulation or removal.

According to one aspect of the invention this object is achieved by a security device, comprising:
(a) a carrier adapted to be fixed to the gas cylinder;
(b) a RFID-tag provided on said carrier having a storage for storing an expiry date or any other data regarding the durability of the gas contained in said gas cylinder;
(c) a processor for checking the durability; and
(d) a display indicating the durability and/or passing of the expiry date.

With such a device the expiry date is electronically stored. The display will indicate if the expiry date is exceeded. In such a way a manipulation of the expiry date is not easily possible. With the display it can be recognized at once if the expiry date is exceeded or not.

Preferably the carrier comprises an annular security strip adapted to be installed around the gas cylinder neck and means are provided for generating a signal upon removal of the security strip. This makes it difficult not only to manipulate the expiry date but also to remove the device. The signal can be generated in the form of an optical signal on the display. However, instead or additionally acoustic signals may be generated indicating the removal of the security device. Further to optical and/or acousic signals an alarm signal can be sent to a server with a reader by the RFID-tag upon removal or manipulation of the device.

In particular, means for removing stored data and/or destroying the RFID-Tag upon removal of the security strip may be provided. Thereby it is avoided that a security device with a valid expiry date is fixed to a gas cylinder having an invalid expiry date. A manipulation of the expiry date by exchanging RFID-tags is, therefore, impossible.

In a particularly simple embodiment of the invention the display is an assembly of 1 to 3 LEDs having different colors and illuminated depending on the remaining durability, For example, three LEDs may be used having the colors red, yellow and green. Like a traffic light they can easily indicate the durability of the gas. Red means, that the expiry date has been exceeded. Green means, that the expiry date in not yet reached with sufficient time difference. Yellow means that the expiry date will be reached in the near future. It is understood that obviously only one LED may be used instead of three LEDs, the one LED having the capability of illuminating with three different colors. Also, the yellow LED must not necessarily be used.

In a further modification of the invention the display generates a signal which is variable in time depending on the remaining durability. This enables also the display to be read by color-blind persons. The signal can be formed by flashing, for example. Simple flasks mean that there is a sufficiant durability. Three flashes mean, that the expiry date has been exceeded. Two flashes mean, that the expiry date is reached in the near future. This embodiment is particularly useful if only one LED with different colors is used

The security device may be provided with an internal clock or a receiver for receiving a clock signal. The clock may be a receiver for radio signals or other time signals, for example emitted in a WLAN (Wirless local area network).

In a farther modification of the invention the RFID-tag is an active tag with its own energy supply, the REID-tag frequently emitting a signal containing information about the durability of the gas, theft and/or manipulation. In particular, the RFID tag may be remote controlled. The signals may be received by a suitable receiver and evaluated.

Thereby, logistics is facilitated, The data stored in the REID tag may also be read out on demand by means of a reader and evaluated at a server.

For securing the gas cylinder against theft an acceleration sensor, a tilting sensor and/or an analog signal sensor such as a flow sensor or a pressure sensor may be provided. Movements which are not intended are indicated on the display or an alarm signal is emitted. If the gas cylinder is intended to be moved or any other handling of the gas cylinder is intended the sensors may be swiched off. A temperature sensor may be provided in order to determine if the temperature is outside a given temperature range.

The invention also relates to a security device for gas cylinders which are characterized by
(a) a carrier adapted to be fixed to the gas cylinder or crate;
(b) a RFID-tag provided on said carrier;
(c) a processor;
(d) a closed electric circuit with a current- or voltage supply adapted to be switched off, and
(e) means for generating an optic-, acoustic- and/or wireless transmittable alarm signal upon disruption of the electric circuit.

The carrier may comprise an annular security strip with a conductor, said conductor forming a portion of the closed electric circuit. If the security strip is cut or broken, as it is the case when it is removed or tampered with, the circuit is interrupted. The signal generated thereby is converted to an alarm signal which may be, for example, wireless transmitted. The electric circuit may also extend through the gas cylinder by two electric contact points. The removal of the carrier is detected by the disruption of the contacts.

Further modifications of the invention are subject matter of the subclaims. An embodiment is described below in greater detail with reference to the accompanying drawings.

### BRIEF DESCRIPTION OF THE DRAWINGS

FIG. 1 is a perspective view of the upper portion of a gas cylinder with a valve and a security strip.

FIG. 2 is a side view of the assembly of FIG. 1.

FIG. 3 is a cross sectional view of the assembly of FIG. 2.

FIG. 4 is a top view of the security strip of the assembly of FIG. 1 with a miniboard.

FIG. 5 is a cross sectional view of the security strip of FIG. 4.

FIG. 6 is a perspective view of a glas cylinder with a security strip without a threaded collar.

FIG. 7 shows the gas cylinder of FIG. 6 with a threaded collar where the security strip is clamped between the threaded collar and the shoulder of the gas cylinder and a key of a key and slot connection for securing the threaded collar.

FIG. 8 shows the gas cylinder of FIGS. 6 and 7 with a valve installed on the neck of the gas cylinder.

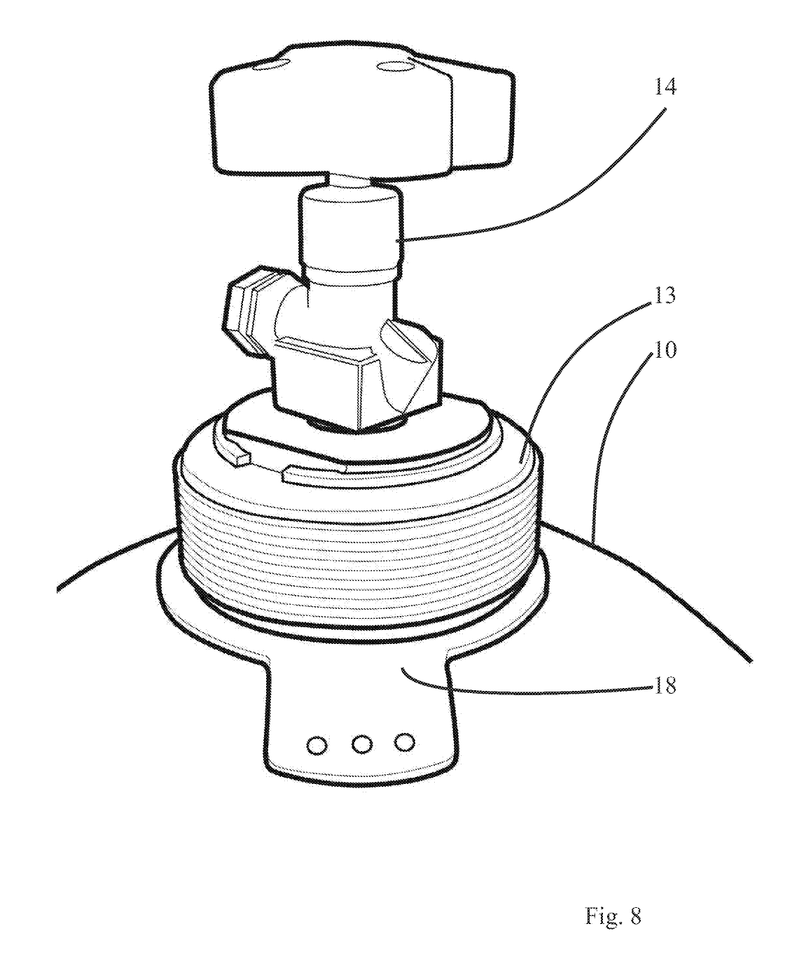

FIG. 9 illustrates an alternative embodiment during screwing the security strip on the threaded collar of a gas cylinder,

FIG. 10 shows the embodiment of FIG. 9 with a security strip and a cap readily screwed on.

### DETAILED DESCRIPTION OF A PREFERRED EMBODIMENT

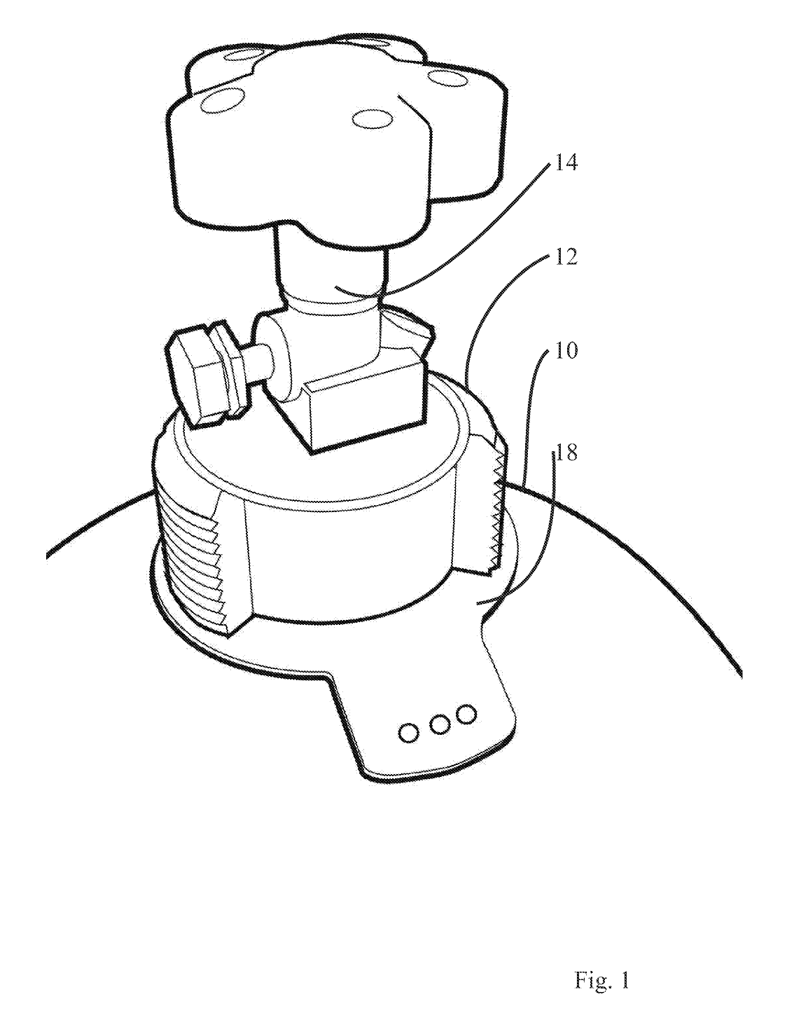

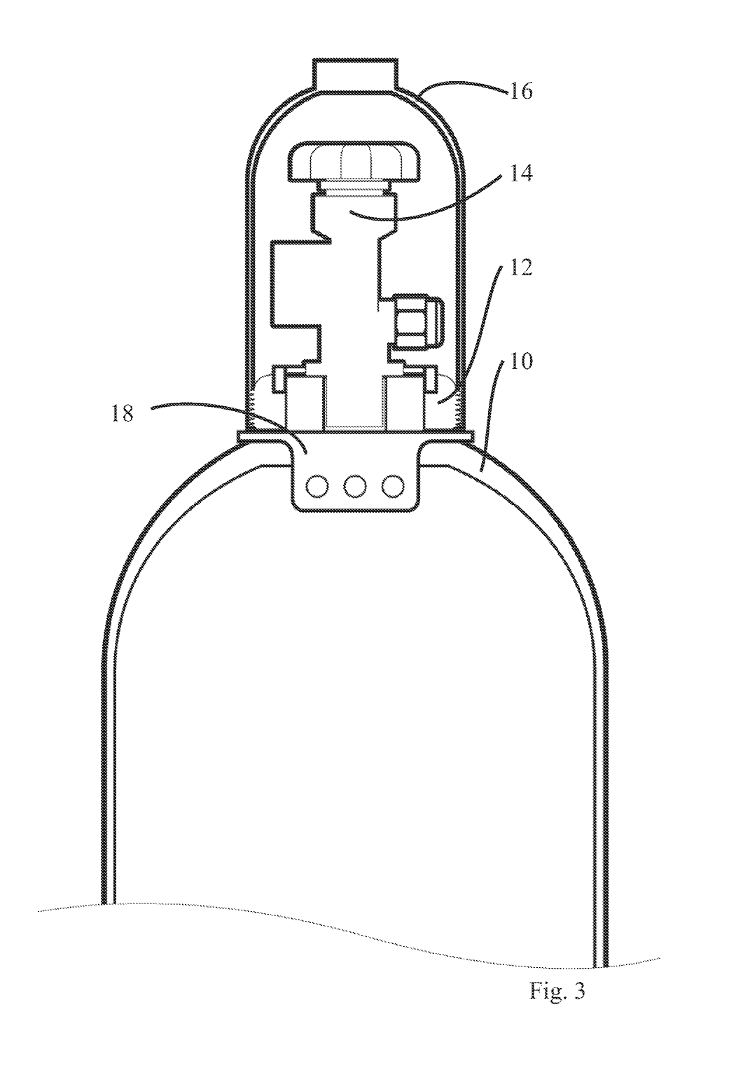

FIGS. 1 to 3 show a gas cylinder generally denoted with numeral 10, Such a gas cylinder is a pressurized container for transporting and storing gases and mixtures of gases. Typical gas cylinders have volumes of up to 150 litres. The gases maxh have a very high pressure of up to 300 bar. Depending on its content and the purity gas cylinders typically are made of alumina, stainless steel or tempered steel. The gases are used in the industrial production, in medical applications, for chemical and pharmaceutical purposes and in many other applications. For many applications it is important that the properties are known, such as content, composition, producer, production- and expiry date, purity, admited application, storage position, storage temperature, required safety measures and the like. Furthermore, it is important to be able to track the gas cylinders and to prevent theft,

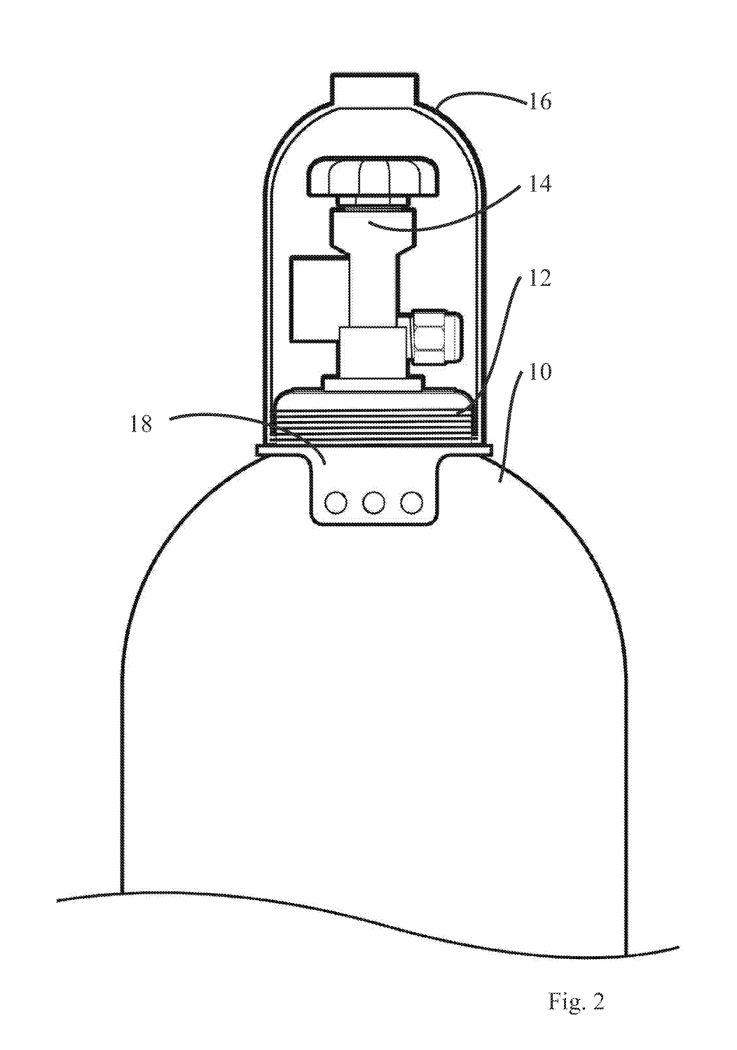

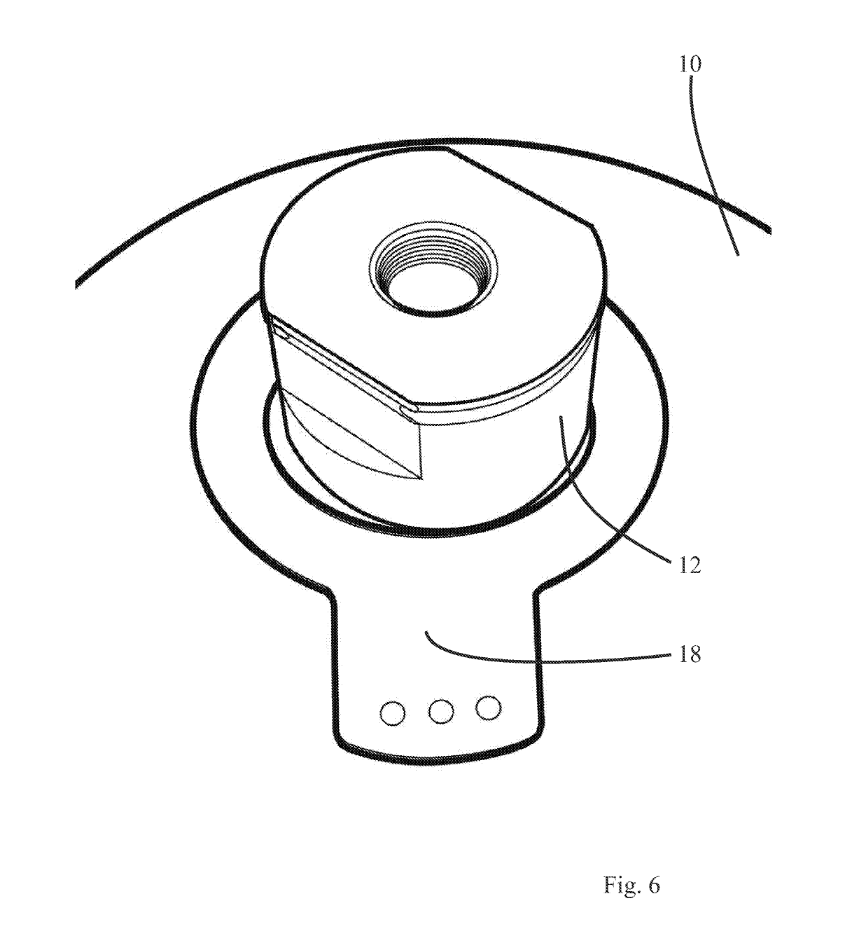

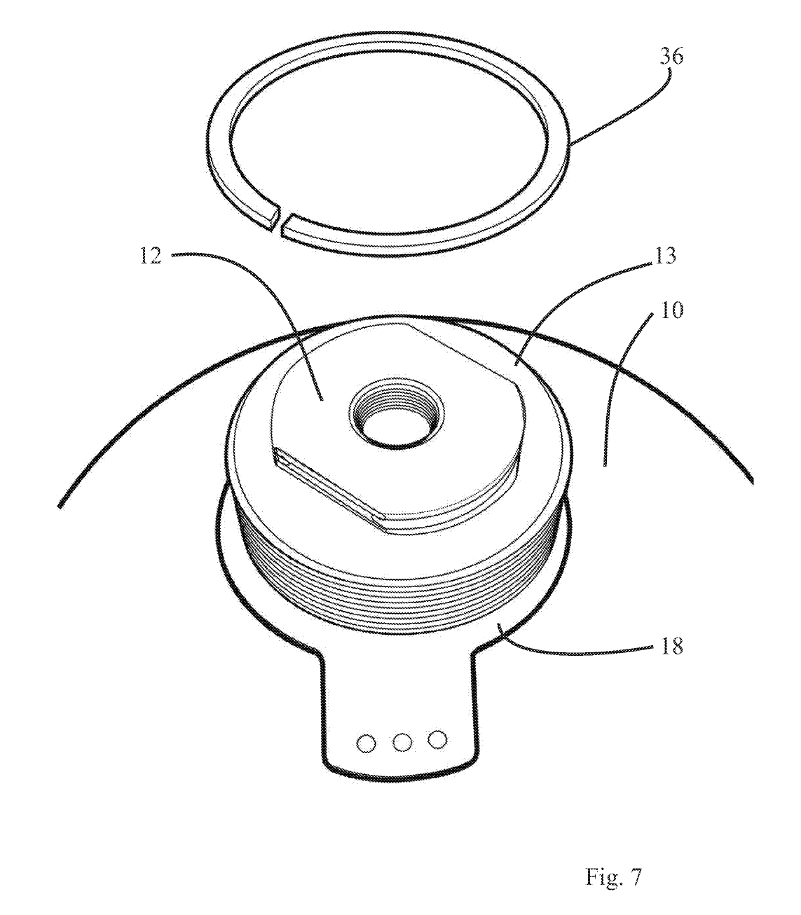

The gas cylinder 10 is provided with a neck 12. The neck 12 is an integrated portion of the gas cylinder 10, This can be seen in FIG. 6. A threaded collar 13 is mounted on the neck 12. The threaded collar 13 has an outer thread. The threaded collar 13 is secured with a key 36 in an axial direction the key engaging in a corresponding slot, this can be seen in FIG. 7. A valve 14 is inserted in the neck 12 which is used to take a desired. amount of gas. With such an assembly the threaded collar may be replaced if the thread of the threaded collar 13 is used up. A cap 16 shown, for example, in FIGS. 2,3 and 10 secures the valve 14 in usual way by screwing the cap on the threaded collar.

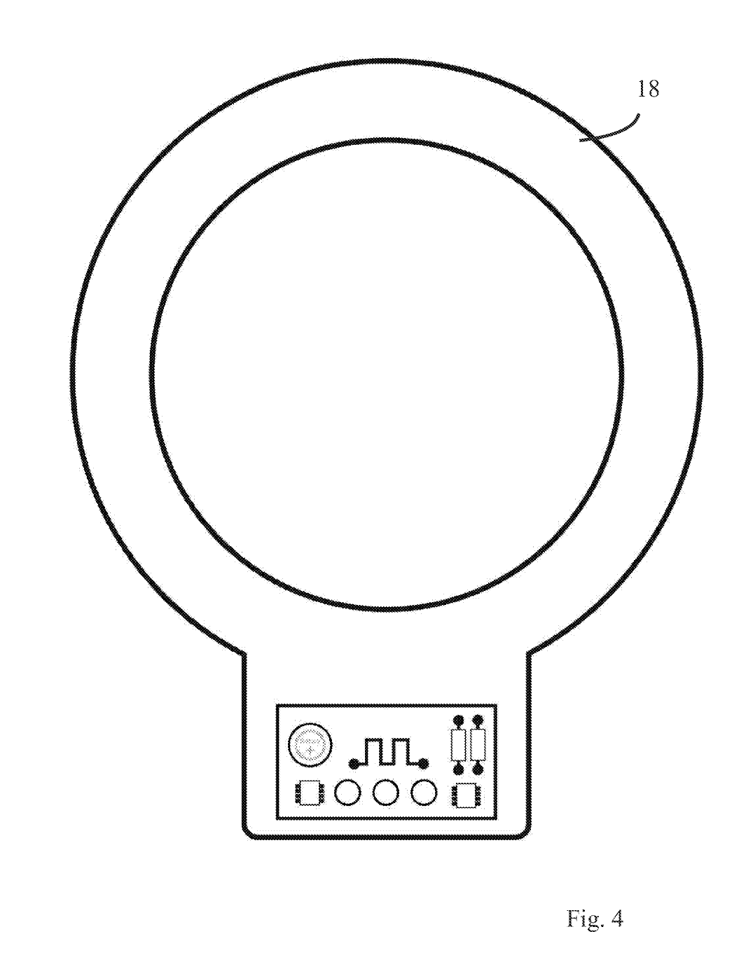

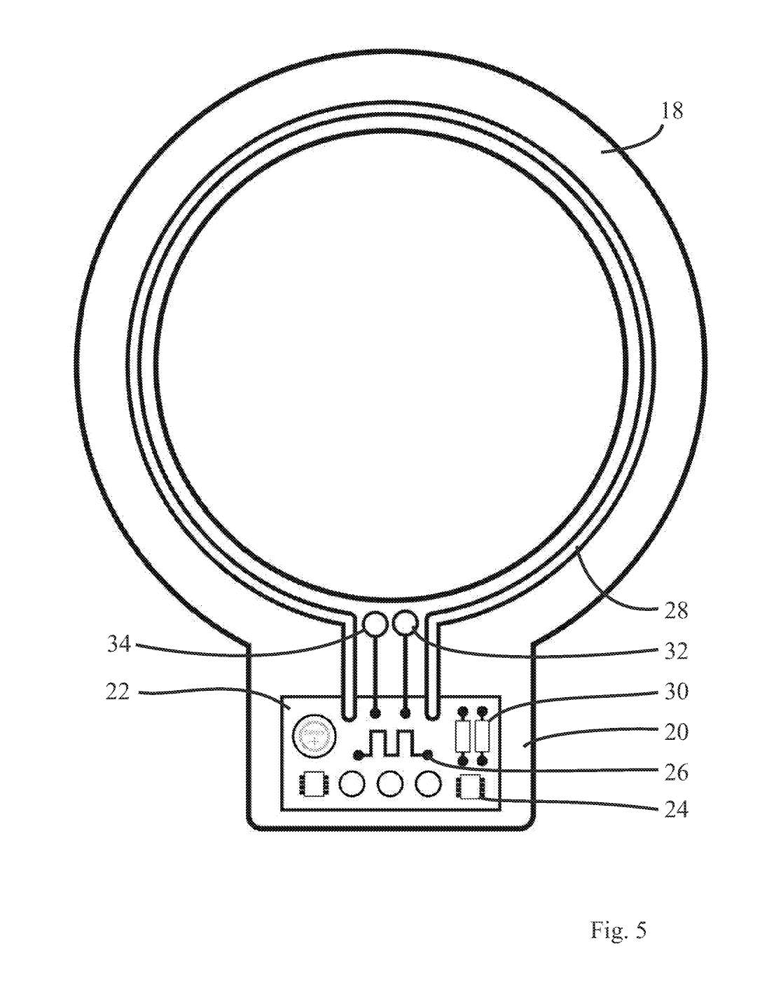

An annular security strip 18 is positioned around the neck 12 on the shoulder of the gas cylinder 10. The security strip 18 is clamped between the lower edge of the threaded collar 13 and the shoulder of the gas cylinder 10, The security strip 18 is separately shown in FIGS. 4 and 5.

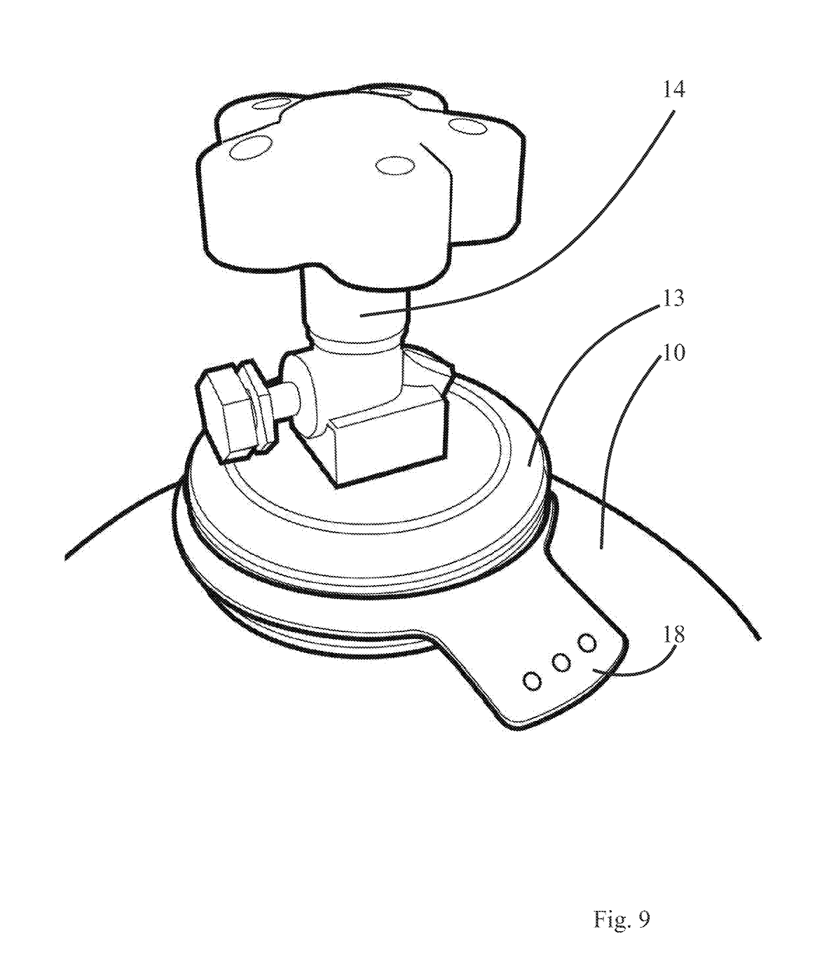

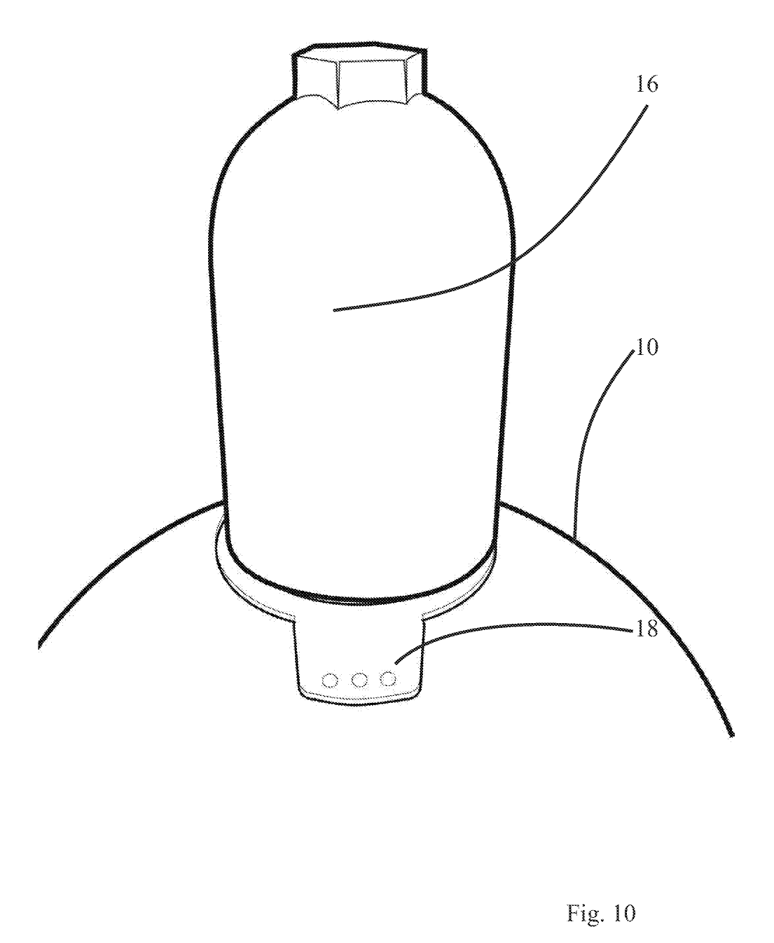

In an alternative embodiment the security strip is provided with an inner thread. The security strip is then screwed onto the threaded collar 13 until it is positioned. resting on the shoulder of the gas cylinder 10, This is shown in the embodiment illustrated by FIGS. 9 and 10.

The security strip 18 consists of plastic material and has a tongue 20, A miniboard 22 with processors 24 is arranged. on the tongue 20. The processors 24 serve to control the functionality of the security device formed by the security strip 18 and the miniboard 22. An active RFID-tag 26 is provided on the miniboard 22. The RFID-tag stores information regarding content, composition, producer, production- and expiry date, purity, admitted applications, storage position, storage temperature, required safety precautions, and various codes, The RFID-tag 26 frequently emits such data. The emitted signals are received by a server and evaluated. The data may also read out on demand by a reader or an emission may be triggered by a remote control.

A conductor 28 extends along the annular security strip 18. A weak electric power source 30 is provided on the miniboard 22. The electric power source is connected with the metal surface of the gas cylinder through two contacts 32 and 34. The coating of the gas cylinder is removed at the contact points 32 and 34. In such a way a closed electric circuit is formed through the gas cylinder 10 and the contacts 32 and 34 with the electric power source 30. if the security strip 18 is removed, by, for example, theft or for manipulation purposes, the contacts 32 or 34 and thereby the electric circuit is interrupted. In this case, an alarm signal is generated and converted by the processors 24. The alarm signal is emitted by the RFID tag, it may be detected by a receiver thereby enabling to instantly take suitable measures for securing the gas cylinder. The conductor 28 also forms a closed electrical circuit, If this circuit is interupted by, for example, cutting the security strip, this will cause an alarm in a similar way as with the first electric circuit.

A server with a reader is provided in the receiving range of the RFID-tag. The reader serves to read out information on the RFID-tag. The RFID-tag frequently sends status information to the server. If the signal is missing or is interrupted an alarm is generated. Such signals may be missing due to defects, destruction or removal of the security device or, the entire gas cylinder outside the reading range of the reader.

Three LEDs having the colors green, yellow and red are provided on the miniboard 22. It is frequently checked by the processors 24 if the expiry date is reached. A clock is provided on the miniboard 22 for this purpose. If the expiry date is reached the red LED flashes. If the expiry date is reached in the near future, the yellow LED is illuminated. If the expiry date is in the far future, the green LED is illuminated.

The security device described above may easily store and provide any information relating to the gas cylinder. It enables quality control of the system during manufacturing. The gas cylinder can be tracked, found and secured with the RFID-tag in addition to having a display indicating the expiry date.

The embodiments were described above in great detail. It is, however, understood, that many variations and changes may be applied to the invention without deviating from the general idea of the underlying invention. The described details only serve for illustration purposes and are by no means meant to limit the scope of protection which is defined by the appending claims only.

1. A security device for gas cylinders or crates of gas cylinders, said gas cylinders having a neck and containing a gas having a limited durability or an expiry date, comprising
a carrier adapted to be fixed to a gas cylinder or crate;
a RFID-tag provided on said carrier having a storage for storing said expiry date or any other data regarding said durability of said gas contained in said gas cylinder;
a processor for checking said durability; and
(d) a display indicating said durability and/or passing of said expiry date;
and wherein
said processor and said display are provided on said carrier fixed to said gas cylinder.

2. The security device of claim 1, and wherein said carrier comprises an annular security strip adapted to be installed around said neck of said gas cylinder and means are provided for generating a signal upon removal of the security strip.

3. The security device of claim 2, and further comprising means for removing stored data regarding said durability of said gas and/or destroying said RFID-Tag upon removal of said security strip.

4. The security device of claim 1, and wherein said display is formed by 1 to 3 LEDs shining with different colors depending on the remaining durability and/or passing of said expiry date.

5. The security device of claim 1, and wherein said display generates a signal which is variable in time depending on said durability.

6. The security device of claim 1, and further comprising an internal clock or a receiver for receiving a clock signal.

7. The security device of claim 1, and wherein said RFID-tag is an active tag with its own energy supply, said RFID-tag frequently emitting a signal containing information about said durability of said gas, theft and/or manipulation.

8. The security device of claim 1, and wherein an acceleration sensor, a tilting sensor and/or an analog signal sensor such as a flow sensor or a pressure sensor and/or a temperature sensor is provided.

9. A security device for gas cylinders or crates of gas cylinders, comprising
(a) a carrier adapted to be fixed to at least one of said gas cylinders or at least one of said crates of gas cylinders;
(b) a RFID-tag provided on said carrier;
(c) a processor;
(d) a closed electric circuit with a current- or voltage supply adapted to be switched off; and
(e) means for generating an optic-, acoustic- and/or wireless transmittable alarm signal upon disruption of said closed electric circuit.

10. The security device of claim 9, and wherein said carrier is an annular security strip with a conductor, said conductor forming a portion of said closed electric circuit.

11. The security device of claim 9, and wherein said electric circuit extends through said gas cylinder by two electric contact points.

12. Method for securing gas cylinders against theft and/or manipulation, comprising the steps of:
(a) providing a RFID-tag
(b) storing information about said gas cylinder on said RFID-tag;
(c) frequently transmitting said stored information or portions thereof from said RFID-tag to a remote server;
(d) generating an alarm signal at said remote server if said transmission is interrupted.
